(19) United States
(12) Patent Application Publication
(10) Pub. No.: US 2005/0046375 A1
(43) Pub. Date: Mar. 3, 2005

(54) Software-based adaptive control system for electric motors and generators

(76) Inventors: Boris A. Maslov, Reston, VA (US); John Salatino, Dulles, VA (US); Guohui Yuan, Gaithersburg, MD (US)

Correspondence Address: MORRISON & FOERSTER LLP, 1650 TYSONS BOULEVARD, SUITE 300, MCLEAN, VA, 22102, US

(21) Appl. No.: 10/736,791

(22) Filed: Dec. 17, 2003

Related U.S. Application Data
(63) Continuation-in-part of application No. 10/359,305, filed on Feb. 6, 2003.
(60) Provisional application No. 60/399,415, filed on Jul. 31, 2002.

(51) Int. Cl. H02P 5/06

(52) U.S. Cl. 318/650

(57) ABSTRACT

A control system for motors, generators and other electric machines that improves machine performance by dynamically adapting to changes. These changes may be in user inputs, machine operating conditions and/or machine operating parameters. The control system can take advantage of more independent machine parameters. That gives greater freedom to optimize and allows motors and generators to perform better than bigger, heavier machines, particularly more efficiently. The control system is software-based. So standard interfaces allow the control system to be improved and updated without changing hardware. This adaptive control system improves performance in a wide variety of motor and generator applications, particularly those that need high efficiency over varying conditions.

### STATEMENT OF RELATED APPLICATIONS

This application is a continuation-in-part of U.S. application Ser. No. 10/359,305 filed Feb. 6, 2003, which application claims priority from commonly assigned, copending U.S. application Ser. No. 09/826,423 of Maslov et al., filed Apr. 5, 2001, commonly assigned, copending U.S. application Ser. No. 09/826,422 of Maslov et al., filed Apr. 5, 2001, commonly assigned, copending U.S. application Ser. No. 09/966,102, of Maslov et al., filed Oct. 1, 2001, commonly assigned, copending U.S. application Ser. No. 09/993,596 of Pyntikov et al., filed Nov. 27, 2001, commonly assigned, copending U.S. application Ser. No. 10/173,610, of Maslov et al., filed Jun. 19, 2002, commonly assigned, U.S. Application Ser. No. 60/399,415, of Maslov et al., filed Jul. 31, 2002, commonly assigned, copending U.S. application Ser. No. 10/290,537, of Maslov et al., filed Nov. 8, 2002, commonly assigned, copending U.S. application Ser. No. 10/353,075 of Maslov et al., filed Jan. 29, 2003, and commonly assigned, copending U.S. application Ser. No. 10/353,075 of Maslov et al., filed Jan. 29, 2003, each of which is hereby incorporated by reference in its entirety.

### FIELD OF INVENTION

This invention relates to adaptive control systems for electric motors and generators.

### BACKGROUND OF THE INVENTION

### Problems with Existing Electric Motors

Existing control systems for electric motors and generators do not provide peak performance in many applications. Electric motors and generators have a well-deserved reputation for efficiency. But often that efficiency falls dramatically when operating conditions change quickly and often. And existing control systems have other disadvantages.

### Existing Adaptive Control Systems

An adaptive control system is one which tunes itself, changing its own parameters as a function of time, in an effort to improve performance or robustness of the closed-loop control system. During the last decade, many important advances have been made in adaptive control.

Existing adaptive control systems can be deterministic or stochastic. Conventional linear control, such as proportional integral differential (PID) methods, can no longer satisfy the stringent requirements of advanced electric machine applications, such as electric vehicles. So many modem control strategies have been developed in recent years.

Most of these methods tune controller parameters to achieve stability and other performance criteria. Examples are model-referencing adaptive control (MRAC), adaptive backstepping, self-tuning control (STC), variable structure control (VSC), fuzzy control, and neural network control (NNC). Even using these advanced control strategies, control systems designers have not been successful in solving many problems with existing control systems.

### No Effective Control Systems for Varying Conditions

Electric machines do not perform well under conditions that may vary rapidly. Electric cars provide one good example. Powering vehicles with electric motors poses real problems. Operating conditions change constantly. Starting requires high torque at low speed. Cruising requires efficiency. Limits on battery power restrict range. Passing on a highway requires bursts of high torque at high speeds.

Electric motors, and their control systems, do not handle these performance demands well. They are much better suited for optimizing performance at a steady speed. In fact, no existing electric motor can deliver, at high efficiency and at a competitive cost, the performance demands of a car across its entire driving cycle.

Fans and pumps provide another example. Over 50% of the electric motors used in industry drive fans and pumps. Electric motors do not perform well at variable speeds. So most fans and pumps use some form of flow control to match supply with demand.

Typically, this means that some mechanical method (such as a damper on a fan or a throttle valve on a pump) controls flow. These methods waste energy by increasing the resistance to flow. Or flow is controlled by running the fan or pump away from its most efficient speed. That too wastes energy.

A windmill generator provides another example. Generating electricity from wind power poses real problems. Wind speed and direction change frequently. Strict limits govern weight and size inside the wind turbine. The power grid requires a fixed frequency to be fed into it. Yet rotational speed may affect the frequency of the power generated.

Current windmill generator designs must make trade-offs to address these issues. Some use efficiency-robbing step-up gears, complex electrical systems to deliver constant power at variable turbine speeds, or fixed-speed designs that produce loud noise at low wind speed. No existing generators do this well enough to be practical for areas with lower or fast-changing wind speeds.

### Compromises Required in Existing Designs

Electric motors and generators are often chosen for the performance they deliver. A variety of types of electric machines exist—induction, synchronous, switched reluctance, brushless DC—each type with its advantages and disadvantages.

While electric generators and motors of these various types have been improved, no type of electric machine avoids making compromises: accepting disadvantages in some areas to get benefits in other areas. An electric machine that can adapt to a wide range of operating conditions, always providing peak performance, does not exist.

Because compromises are so difficult to avoid, one attempt to make a practical electric propulsion system for a car, U.S. Pat. No. 5,549,172, goes to the extreme of using two motors in the car. That invention recognizes that no existing motor performs well over the whole range of car operating conditions.

Accordingly, that invention tries to upgrade overall system performance by combining a highly efficient motor at low speeds with a highly efficient motor at high speeds. The obvious disadvantage is the need for two complete, separate electric motors, and a central control scheme that regulates when each motor is used.

### Custom Motor and Generator Designs Required

To get peak performance from an electric motor of a given size and weight requires a custom motor and controller design. To meet different performance goals for a different application, that custom design must be modified. Using the same motor design for different applications will save time and money. But it will also sacrifice performance.

Computer and power electronics technologies continue to advance. As they do, motor designs more often take advantage of new control options. In many cases, the line between design of the motor and design of the motor control is becoming less distinct.

This blending of motor and control technology offers new opportunities to motor designers and control designers. They can work together to develop even more powerful and efficient electrical motors. But with existing control systems, a motor and control system must still be custom designed “from the ground up” to get peak performance.

Electric machine designers and manufacturers have difficulty implementing and fine tuning of adaptive electric machines in actual applications. Hardware control systems must be physically modified to fine tune them during development, and hardware can be upgraded and improved only by replacement.

### Key Goal function Cannot Be Met

Existing control systems for electric motors and generators cannot meet key goal function. For example, in most electric motors, useful torque rapidly decreases with the increase in speed of the motor. That is one of the biggest drawbacks of conventional electric motors.

Conventional control systems for electric motors cannot actively manage torque well, or influence the torque at a design level. That is because the choice of a specific type of conventional motor for a particular application largely determines the available torque profile. It cannot be changed during motor design, let alone during motor operation.

As a result, conventional motor control systems and strategies used within electric cars often cannot even ensure a relatively simple goal: that the motor accurately provide the torque requested by the car's driver. Let alone provide more sophisticated strategies that ensure that the motor always provides peak performance.

Effective motor control presents a major problem beyond just electric cars. For a more general example, electric motor parameters vary with currents, temperature and frequency. In particular, magnetizing inductance, which will be saturated when flux current is high, may be an important parameter in vector control of a motor.

If a control system could adapt to changes in magnetizing inductance, and other motor operating conditions, that helps provide peak performance over a wide range of operating conditions. Existing control systems do not do that.

Improving control of electric motors has long been a goal. Existing motors are designed to be highly efficient. Unfortunately, in most cases that efficiency is limited by the motor and control system design to a narrow range of operating speeds. The motor is not dynamically controlled to be consistently efficient as parameters vary during use over a wide range of operating conditions.

Existing control systems usually cannot deliver many desired goal function of an electric machine, particularly over a wide range of operating conditions. Difficult goal function for existing control systems include efficiency, torque ripple, continuous torque output, mechanical and acoustical noise, excessive hysteresis, eddy current and anomalous core losses, adequate thermal management, mutual inductance and cross talk (transformer effects).

### Attempts to Improve Machine Control

Many attempts have been made to improve machine control. For example, some conventional three-phase motors try to introduce several independent higher order harmonics in the sine-wave shape of the current injected into each of the three phases. These harmonics add some variation to the current shape to be injected.

But no real success has been demonstrated in improving motor performance through the use of higher order harmonics. Or for that matter, any other attempts to use distorted excitation currents in motors.

Other factors or variables have been used more successfully to affect the performance of electric motors, such as the dimension or size of the air gap. Varying the size or shape of the air gap between the rotor and stator of an electric machine according to the operating speed of the machine may improve its performance.

For example, with a “brushless DC” motor design, increasing the air gap as speed increases will help reduce problems with back EMF. But the benefits may not outweigh the drawbacks. The cost and complexity of making the air gap variable probably outweigh any benefits from varying the air gap during operation.

Another example is varying the numbers of coils or turns energized at different windings of the motor. For example, the windings on an electromagnetic pole may have a switch halfway along the winding. Depending on the speed of the motor, the switch is used to allow current to flow through the entire winding (at low speed) or just half the winding (at high speed).

Here again, this may reduce problems with back EMF. But also again, this brings higher costs and complexity. In most cases this will require relays with relatively low reliability and poor total lifetime characteristics. The benefits probably do not outweigh the drawbacks.

Yet other existing arrangements try to resolve the same issue by introducing segmented motors. In these motors, separate physical segments of the motor can be independently activated or energized.

Most often this is done in the form of an axial air gap flux motor with several stator assemblies coaxially connected to the same shaft or stator frame. But radial flux arrangements are also known. Some names used for such arrangements are segmented electromagnetic motor arrays, cascaded motor arrangements, motor clutching, and the like.

As with all other electromechanical arrangements with partial usage of the total windings and/or stator armature, the benefits may be better performance in a wider range. But the drawbacks may be more weight, low torque density, more cost, more complicated controls, and less reliability, among others.

### SUMMARY OF THE INVENTION

### BRIEF DESCRIPTION OF THE DRAWING FIGURES

FIG. 1 shows a block diagram of one example of a motor control system of this invention.

FIG. 2 shows a block diagram of how a control system interacts with the other systems of an electric machine: electrical system, electromagnetics, and mechanical.

FIG. 3 shows five levels of performance to optimize in an electric machine.

FIG. 4 shows the typical (continuous) torque-speed requirements of an electric motor.

FIG. 5 shows the optimal performance that a particular motor design is theoretically capable of.

FIG. 6 shows how control can be customized to produce an optimal torque-speed curve.

FIG. 7 shows the goal of maximizing the area of high efficiency.

FIG. 8 shows how one control strategy may be used at low speeds, a second at medium speeds, and a third at high speeds.

FIG. 9 shows inputs to the signal and power processing of one example of an adaptive control system of this invention.

FIG. 10 shows the motor feedback parameters of an adaptive control system of this invention.

FIG. 11 shows a schematic for a conventional electric motor.

FIG. 12 shows a schematic for an adaptive electric motor.

FIG. 13 shows a typical goal function for a torque-speed profile (FIG. 13(a)), for a speed-load profile (FIG. 13(b)), and for an efficiency profile (FIG. 13(c)).

FIG. 14 shows a flowchart for one example of an adaptive algorithm for varying motor operation as the demand for torque increases and the motor speed increases.

FIG. 15 shows the signal waveforms used to energize one phase of an electric motor as the motor is asked to provide increasingly high torque.

FIG. 16 shows some waveform profiles that can be used with the adaptive control system of this invention to vary motor performance.

FIG. 17 shows a block diagram of the various hardware components that make up the adaptive control system of this example.

FIG. 18 shows another block diagram of the hardware elements of the adaptive motor control system of this invention.

### DETAILED DESCRIPTION OF THE INVENTION

This invention provides a new type of adaptive control system for motors, generators and other electric machines. This adaptive control system improves machine performance by dynamically adapting to changes.

Most electric machines operate efficiently only within a narrow range of operating speeds. For example, an electric motor used in an electric car may be advertised as having a drive train that is over 90% efficient. Typically, that 90% efficiency is for steady cruising over level ground at relatively slow speeds, with no starts or stops. The drive train will usually be much less efficient, sometimes even 50% or less, over the entire driving cycle of a typical car.

An adaptive control system provides better performance. An electric car with an adaptive control system for its motors, a well-designed motor system, and advanced batteries and central controller, may be 90% efficient as much as 90% of the time, or more. An adaptive control system permits electric machines to provide peak performance over a wide range of operating conditions. These operating conditions may be reflected in user inputs, feedback from the machine, and other monitored or sensed parameters.

Based on all these parameters, the adaptive control system of the present invention calculates the optimal waveform profile for the electric machine. It then drives the electric machine according to that profile. The cycle repeats up to thousands of times per second.

This adaptive control system may take advantage of the maximum number of independent control parameters for any given electric machine. That gives greater freedom to optimize the performance of the motors and resulting machine. In turn, that allows motors and generators to perform better than bigger, heavier machines, particularly more efficiently.

This adaptive control system can be used with almost any motor design, improving performance by improving control. But the most advantages may be gained with an adaptive electric motor, since its architecture allows for more effective control than conventional motor designs.

This invention provides a new type of adaptive control system for motors, generators and other electric machines. An adaptive control system improves machine performance by dynamically adapting to changes. Several other advantages also come from the adaptive control system of this invention.

The goals of a control system, or at least some of the goals, can be summarized as follows.

Optimize and maximize motor or generator performance
Provide standardized design across motor or generator applications
Provide flexible design to be customized to specific applications
Dynamically configurable to adapt to variations in operating conditions
Make wise trade-offs with complexity, cost and size
Manage safety and maintenance issues
Support both distributed and central processing
Adaptive to multi-phase motor or generator configurations

This adaptive control system has the potential to meet the above goals. That allows it to provide many advantages not found in existing control systems, even those that are most advanced and sophisticated.

Better control means better opportunity to optimize. Rather than being forced to accept compromises in selecting the type of motor to use—such as giving up high starting torque to achieve variable speed—this adaptive control system may, because of its adaptive nature, provide optimum performance over a wide range of conditions.

### Peak Performance

This adaptive control system focuses on getting peak performance from a given motor or generator design. It helps provide outstanding overall performance characteristics, which may lead to the opportunity to create applications with performance features previously impossible to achieve.

For example, an electric car powered by a motor with this adaptive control system may not only be efficient, but may offer improved power and range. That may help make an electric car that can finally compete with gasoline cars for consumer attention.

Windmill generators with this adaptive control system might perform well enough to be competitive in areas of medium, and perhaps even low, wind speeds. Existing generators require subsidies to operate in those conditions.

An adaptive control system permits electric machines to provide peak performance over a wide range of operating conditions. These operating conditions may be reflected in user inputs, feedback from the machine, and other monitored or sensed parameters. This adaptive control system may also store in its memory some preset parameters for the particular machine.

Based on all these parameters, this adaptive control system calculates the optimal waveform profile for the electric machine. It then drives the electric machine according to that profile. The cycle repeats up to thousands of times per second.

This adaptive control system takes advantage of the maximum number of independent control parameters for any given electric machine. That gives greater freedom to optimize. In turn, that allows motors and generators to perform better than bigger, heavier machines, particularly more efficiently.

This adaptive control system can be used with almost any motor design, improving performance by improving control. But the most advantages may be gained with an adaptive electric motor, since its architecture allows for more effective control than conventional motor designs.

### Improved Overall Efficiency

One big advantage of an adaptive control system comes from improved efficiency. Most electric machines operate efficiently only within a narrow range of operating speeds. For example, an electric motor used in an electric car may be advertised as having a drive train that is over 90% efficient.

Typically, that 90% efficiency is for steady cruising over level ground at relatively slow speeds, with no starts or stops. The drive train will usually be much less efficient, sometimes even 50% or less, over the entire driving cycle of a typical car.

An adaptive control system provides better performance. An electric car with an adaptive control system for its motors, a well-designed motor system, and advanced batteries and central controller, may be 90% efficient 90% of the time. That's a big difference.

Many fans and pumps have dampers or throttle valves to control flow. These waste energy. An adaptive motor that can operate efficiently at variable speeds provides a much better solution. For centrifugal fans and pumps the power input is proportional to the cube of the speed, while the flow is proportional to the speed.

That means that when speed (or flow) of the fan or pump can be reduced, power consumption can potentially be reduced. Instead of wasting energy by using mechanical flow control in fans and pumps, energy can be saved by using an adaptive motor to drive them at variable speeds.

For some specific machine speed, or for some specific load, or for some other specific condition, a conventional control system may provide the same, or even higher, specific efficiency as the adaptive control system of this invention. But considering the whole range of operation of the machine, or overall efficiency of the machine operating in a real environment, this adaptive control system may well give efficiency that can not be approached by conventional systems.

This adaptive control system may also provide greatly increased efficiency in certain applications. As noted above, this adaptive control system may provide significantly greater efficiency than existing control systems, particularly for machines operating at variable speeds.

Of course, efficiency can be improved only to the degree that there is wasted energy. If a machine's overall efficiency exceeds 90%, there may be little room for improvement.

But in applications such as electric cars where operating conditions vary widely, in some cases this adaptive control system may contribute to gains of as much as 50% greater overall efficiency than a prior art machine. Greater efficiency in an electric motor powering a car extends the range of the car for a given battery set and battery technology adopted—a big benefit.

### Fewer Compromises Necessary

High torque may be another distinguishing feature of this adaptive control system. Conventional control systems for electric motors cannot actively manage torque well, or influence the torque at design level. That is because the choice of a specific type of conventional motor for a particular application largely determines the available torque profile.

Using this adaptive control system, by contrast, may typically provide not only extremely high torque, but also high starting torque. It may also allow for special algorithms to increase torque if necessary, and in general actively manage torque across the range of operating conditions of the motor.

The possibility of optimal performance over a wide range of operating conditions may make this adaptive control system suitable for the most demanding applications, like propulsion, vehicle transportation applications, and other special applications. Specifically, the extremely wide range of operational speeds that this adaptive control system permits may eliminate the need for mechanical gears and transmissions in applications where they were previously necessary.

### Advantages of Software Implementation

This adaptive control system may generally be software-based. So standard interfaces allow the control system to be improved and updated without changing hardware. Future upgrades may be done on a software level only, greatly reducing the cost of upgrades. An adaptive motor control that would otherwise be obsolete need not be replaced, just updated.

Design benefits also apply. Changes to customize this adaptive control system may be made in software only. Creating a new custom control system design in hardware requires costly prototypes and manufacturing, in addition to design work. Creating a new custom control system design in software is much easier.

Unlike hardware, copies of software can be made at virtually no cost. That means that a sophisticated control algorithm, once developed, can be cheaply reproduced. That may allow implementation of sophisticated control algorithms, too expensive to implement through analog electronics.

A software-based adaptive control system may provide a great benefit to designers and manufacturers. Software implementation allows easy implementation and fine tuning of electric machines in actual applications. That may reduce or eliminate the need for costly prototypes and testing.

Hardware control systems must be physically modified to fine tune them during development, and hardware can be upgraded and improved only by replacement. With software, much of the fine-tuning, as well as future upgrades and improvements, can easily be done on a software level within the same topology, hardware, and controller of a specific electric machine.

Most adaptive machine controllers may turn out to be digital, microprocessor-based, programmable controllers. The importance of software and proper software development for such controllers may be very important. In fact, all the means for forming specific waveforms may well be implemented on a software level, not in hardware.

That simple statement, in fact, may indicate an enormous advantage of adaptive electric machines. That may lead to the ability of motors with this adaptive control system to adapt to operating conditions, their ability to operate in ways impossible for conventional machines, their software re-configuration ability, their ability to be easily upgraded, and the like. A whole roster of software benefits may come into play.

With this adaptive control system, it may be possible for the electric machine to be upgraded by software. While the basic machine structure may remain fixed, many important characteristics of the machine, such as the control scheme, may be upgraded by modifying the software. Preferably, this may be done remotely or over the Internet, where software will be available for different operating conditions.

Flexible controls may be considered an important distinguishing feature of this adaptive control system. Flexible controls create convenience and uniformity when designing and implementing this adaptive control system in any application. Additionally, as mentioned above, controls implemented on the software level bring the possibility of future upgrades on a software level without actual replacement of the motor or controller and allow flexibility for multi-phase winding configurations.

That software-upgrade ability may not only save costs when upgrading, but may also allow the accommodation of existing implementations of this adaptive control system to future, as yet unknown, tasks as they appear, without requiring actual physical replacement of the machine. It may also give developers and users the flexibility of software design versus hardware changes.

### Adaptive Control Systems Permit Overall Control

This adaptive control system normally uses digital-based programmable controllers. These controllers can greatly facilitate the control of the overall application that uses an electric machine, and make software an important part of overall control.

This leads directly to great cost savings during development, implementation, operation, and upgrade of any specific electric machine. Because of these benefits, electric machines with this adaptive control system are attractive for implementation and use by designers and manufacturers of specific applications, and for ultimate end users of those applications.

Having this adaptive control system in many applications can permit many problems to be addressed at a new level. Problems that could not be addressed by motor control in an electric car, for example, can now be solved by adaptive control.

For example, to improve energy efficiency, this adaptive motor control system can adapt almost instantaneously to an adaptive electric car's operating conditions. This may include starting, accelerating, turning, braking, and cruising at high speeds. To improve motion control, the motor controller can work with the central controller of the electric car to directly and almost instantaneously adapt the motion of the wheels to changes in road conditions or driver inputs.

This adaptive control system can also improve operation of electric motors to reduce noise, vibration and harshness (“NVH”), eliminate or reduce audible noise, control load spikes, and provide fail-safe operation. In addition, this adaptive control system can be used to compensate for changes in motor operation due to wear and tear, and to reduce torque ripple and other poor motor characteristics.

In fact, this adaptive electric motor control technology may influence the whole design concept, general approach and technology of an electric car. With an adaptive control system comes total electric and electronic control of the car.

All of the motor control may be implemented in software, so that the basic control algorithms can be modified by loading new or upgraded software, without replacing any hardware. If desired, this could be done remotely, such as over the Internet. In addition, fault detection and repair may be done remotely in some cases.

With a centralized electronic control system for a car and its propulsion system, one can easily imagine endless future design opportunities. These include centralized traffic control, route programming, cruise control, auto-piloting of a car, accident prevention, recovery of lost and stolen cars, ability to deliver service, repair and upgrades to a car electronically or wireless as-you-go, future software upgrades of a car, and the like.

Adaptive electronic control of the entire car provides the chance to use control of each wheel's rotational dynamics to control the lateral dynamics of the car's chassis. “Drive-by-wire” and other electronic control schemes may replace mechanical linkages. That allows adaptive control to extend throughout the adaptive electric car.

### Whole Spectrum of Improved Performance

Existing motor control systems, even existing adaptive control systems, usually focus on functional requirements, such as torque, speed and power. They provide no real opportunity to optimize other areas.

The adaptive control system of this invention opens up the possibility of a whole spectrum of improved performance. In addition to optimizing functional requirements, this adaptive control system may optimize other areas. This may include performance quality, system efficiency, system safety, and fault tolerance.

For example, the limitations of conventional electric machine technology allow designers to achieve only a very rough and approximate match with desired performance characteristics. In many cases this leads to the necessity of using reducers and gears with the machine, and in many cases leads to the inability to develop an application that satisfies in full some specific need of the ultimate user.

One key objective of this adaptive control system may be to increase the number of variables controlling the operation of the electric machine, but in such a way that each variable contributes considerably to machine operation. With some electric machines, increasing the number of variables may lead to diminishing returns, where changing the variables starts to have little, if any, predictable, desired effect.

But if the design of an electric machine allows it, reaching this key objective of a large number of variables, each with a substantial effect, may enable a whole spectrum of improved performance. Standard control objectives, such as delivering required torque at a given motor speed, may be reached, and then substantially and radically expanded.

Although there are still trade-offs, now a variety of performance objectives may also be achieved, such as maximizing the motor's efficiency as operating speed varies, reducing acoustic and mechanical/electromechanical noise, managing torque ripple, and optimizing the current demand off of the power source. Similar performance benefits may become possible for generators.

This adaptive control system may adapt to wear of the components of the machine, so that vibration and noise will not increase even as the machine ages. This adaptive control system may also perform diagnostics to inform the operator when excessive wear or damage pose problems.

### Business Advantages

This adaptive control system may bring several business advantages over existing control systems. Compared to analog controllers, digital-based controllers are generally simple to design, cheap to manufacture, and easy to service and upgrade.

This adaptive control system may allow modular upgrades. Electric machines generally consist of three distinctive modules: an electromagnetic system, a control system, and software. This adaptive control system can easily be implemented with the sophisticated functions implemented in software that runs on a relatively simple hardware platform.

That means upgrades may be done in a partial way by replacing just some components of this adaptive control system. The easiest upgrades to carry out are those involving software, which can usually be done by a simple reprogramming of the controller.

In concept, this resembles upgrading a personal computer with new software. No redesign of the hardware need be done to accommodate the new software. Instead, the software is designed to run on a given hardware platform. Even control algorithms written for a certain motor might be “ported” to a different type of motor fairly simply if the motor characteristics are well-defined.

In most cases, this adaptive control system may have lower system costs than conventional control systems. In part, this is because this adaptive control system may be easier to customize for various electric machine designs. Given the simple hardware platform, and the “black box” nature of the controller, a new design may well be easily and elegantly created from an existing design. Also, digital software-based controls are generally cheaper then similar analog circuits.

This adaptive control system may have lower manufacturing cost. A simple hardware system will be much less expensive to make than a complicated system where sophisticated functions are implemented in hardware. Software may be manufactured cheaply. When the sophistication of the control system is in the software, manufacturing costs are low.

After implementing an initial adaptive control system design, design and integration of other adaptive control systems by the same manufacturer will be smooth and seamless. Limited customization may take the place of a redesign from the “ground up.

The same mathematical models and similar control electronics should allow a shift in concentration in design (and especially in redesign or upgrading) mostly to the software development level. This makes design, redesign, and upgrading much more efficient, with faster development and turnover times and cheaper development processes.

This adaptive control system may be software-based. So standard interfaces allow the control system to be improved and updated without changing hardware. Design benefits also apply. Changes to customize this adaptive control system may be made in software only.

Creating a new custom control system design in hardware requires costly prototypes and manufacturing, in addition to design work. Creating a new custom control system design in software is much easier.

This adaptive control system improves performance in a wide variety of motor and generator applications. Particularly, those machines that need high efficiency over varying conditions will perform better.

An adaptive control system of this invention can take many forms. This detailed description presents one example of an adaptive control system for an adaptive motor used in an electric vehicle. An adaptive motor, as explained in more detail in U.S. patent application Ser. No. 10/359,305, usually has independent electromagnetic circuits.

In this example, each electromagnetic circuit, or “phase,” of the motor has been isolated from each of the other phases. That substantially eliminates electrical and electromagnetic interference between the phases. This usually increases the number of independent machine parameters that may be varied and controlled. As a result, the motor becomes more responsive to control and optimization.

This adaptive control system can be used with almost any motor design, improving performance by improving control. But the most advantages may be gained with an adaptive electric motor—its architecture allows for more effective control than conventional motor designs.

So an adaptive control system for an adaptive motor may be the best example to describe the invention. But this adaptive control system for other motors, generators and electric machines also falls within the scope of this invention.

### Optimization Strategy

The first objective for designing an adaptive control system of this invention may be developing a strategy to achieve the so-called goal function for the electric machine being controlled. That requires identifying the machine parameters that are most desirable from the machine in a specific application.

Designers routinely work with a goal function in trying to achieve required parameters. A real difference in machine design is how early the design process starts to influence major characteristics and parameters of the machine and control system.

The example described here is an adaptive control system for an adaptive motor. In conventional applications for motors, a major decision is what type of motor will be used—AC or DC—and what specific sub-type or narrow group of motor configuration will be considered.

After that major decision, the flexibility left for the designer is already sharply reduced down to few choices. And when the motor is designed down to exact specifications, what really influences performance of the motor is the voltage and current fed to the motor—just two parameters. In multiphase AC motors, some servomotors, and others, the real number of parameters subject to free variation may be larger; perhaps five to six parameters (three voltages and phase angles) in three-phase AC motors.

So in general, designing an adaptive control system of this invention will usually involve three steps. First, identifying the goal function. Second, identifying the input parameters relating to the goal function that can be monitored or sensed. Third, identifying and maximizing the output, or control parameters, that might influence the goal function.

Once this is done, the adaptive control system of this invention can be designed. The central idea behind the adaptive control concept may be this—to actively control enough variables during normal operations of the machine to achieve the specified goal function as closely as possible.

Optimally controlling the motor is a general minimization task of a multi-variable, highly non-linear multiple minima function, commonly called a “loss” or “goal” function. Depending on the control objectives, one can minimize different things.

For example, one can minimize motor losses at a given speed and torque (the most common control objective). Or one can minimize average motor losses in a range of speeds and torques. Or one can minimize torque ripple at a given speed and torque or in a range of speeds and torques.

Often other control goals are formulated. These goals may deal with simple motor-related parameters. That may be minimizing noise or electromagnetic emissions, or producing specific transitional behavior of the motor (for example, providing required acceleration of the motor speed).

Or these goals may deal with optimizing the performance of the complex systems using such motors. That may be minimizing deviation from the specific speed profile of a large conveyor driven by the motor being controlled, or providing the most energy efficient cruise control for an electric motor-driven vehicle on the road.

When all such variable parameters are identified and their influence on the goal function is determined and quantified, the optimization can begin in a mathematical sense. One complex and intricate procedure should be followed first, although it is often overlooked as a whole or purposefully omitted due to extreme complexity.

That procedure is to identify variables that are truly independent from each other (what in mathematics is called to normalize, or make orthogonal, variables in a multi-dimensional variable space). This procedure gives the actual dimension of the variable space—a result the importance of which cannot be overstated.

Reaching this key objective of a large number of variables, each with a substantial effect, may enable many of the benefits of this adaptive control system. Standard control objectives, such as delivering required torque at a given motor speed, may be reached, and then substantially and radically expanded.

Although there are still trade-offs, now a variety of performance objectives may also be achieved. That may include maximizing the motor's efficiency as operating speed varies, reducing acoustic and mechanical/electromechanical noise, managing torque ripple, and optimizing the current demand off of the power source. Similar performance benefits may become possible for generators.

### Achieving a Goal Function

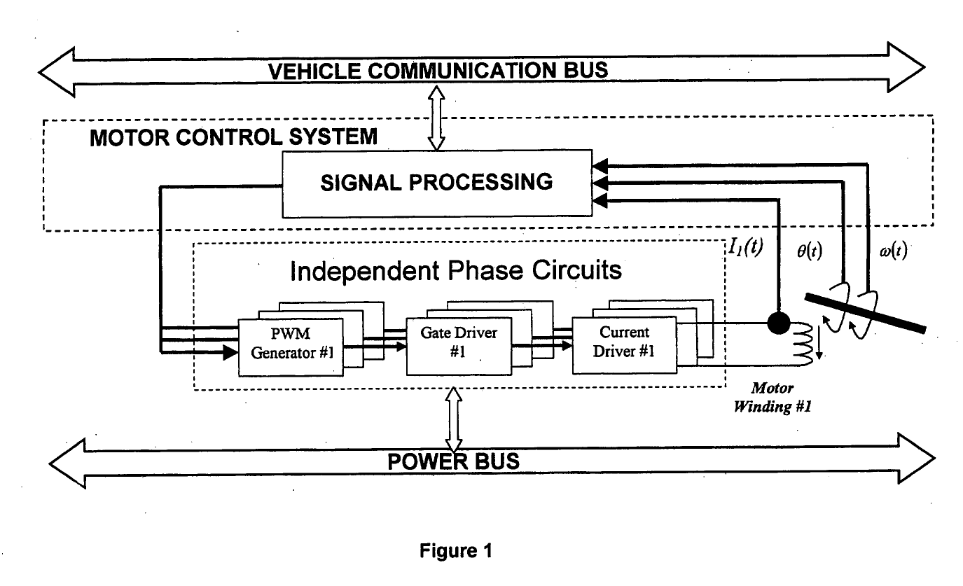

FIG. 1 shows a block diagram of the adaptive control system in this example. The motor control system has a separate, independent phase circuit for each set of motor windings. The circuit for each set has a pulse-width modulation generator, a gate driver, and a current driver. Each current driver sends current to a separate motor winding.

The algorithms used for signal processing form the heart of this adaptive control system. That signal processing uses information about driver inputs and vehicle conditions from the vehicle communication bus. It uses information about the motor, such as the current for each phase, the angular position of the rotor, and the rotational speed of the rotor.

Putting this information together, signal processing generates the optimal waveform profile to drive the motor. As driver inputs, vehicle conditions and motor conditions change, the signal processing in the motor control system dynamically adapts the motor to those changes.

Because software algorithms form the heart of an adaptive control system, a focus on software is important in designing an adaptive control system. Hardware design, while important, just provides the platform for the software to run on. The software, not the hardware, may provide most if not all the key functions of the control system.

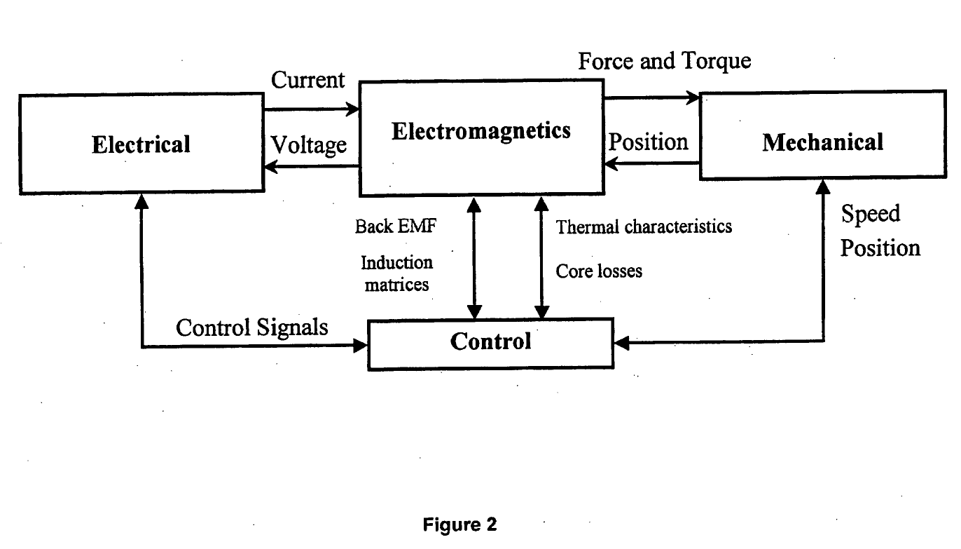

FIG. 2 shows how the control system interacts with the other systems of an electric machine: electrical system, electromagnetics, and mechanical. The control system may be treated during design as a “black box,” implemented in either hardware, software, or a combination of both.

Design strategy for this adaptive control system focuses on supporting optimal performance in changing conditions. In this example of an adaptive control system for an electric vehicle, design strategy focused on five levels of flexibility and five levels of performance.

The five levels of flexibility that can be used by this adaptive control system to optimize performance are:

| | |
|---|---|
| By DESIGN default | (physical) |
| At the FACTORY | (programmable) |
| By the USER | (programmable) |
| Based on MOTOR conditions | (dynamic) |
| Based on VEHICLE conditions | (dynamic) |

The five levels of performance to optimize are:
FUNCTIONAL requirements (torque, speed, power, etc.)
Performance QUALITY (torque ripple, maximum speed, etc.)
System EFFICIENCY (of motor, controls, power distribution, etc.)
System SAFETY (fault diagnostics, operating limits, etc.)
FAULT tolerance (redundancy, performance monitoring, etc.)

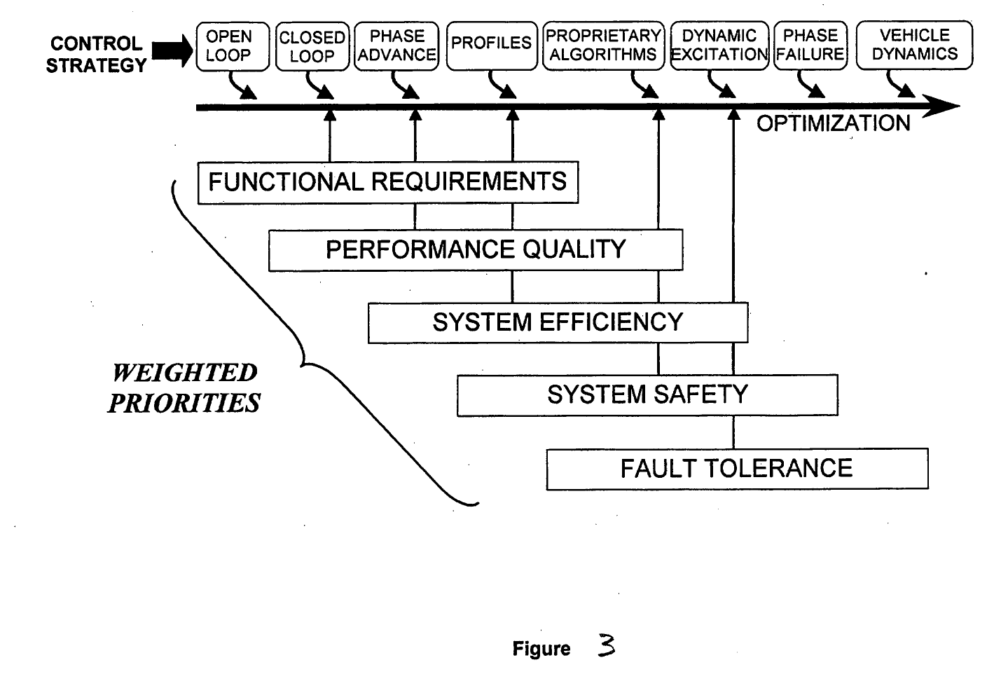

These five levels of performance can be assigned a weighted priority, as shown in FIG. 3. Increasingly advanced control strategies may then be implemented to optimize the different levels of performance, depending on their chosen weight. These become the goal function that the adaptive control system is designed to achieve.

For example, a control strategy might be designed to handle “phase failure,” the failure of one electromagnetic circuit, or phase, of the motor. That control strategy can help optimize the motor to meet the system safety and fault tolerance levels of performance.

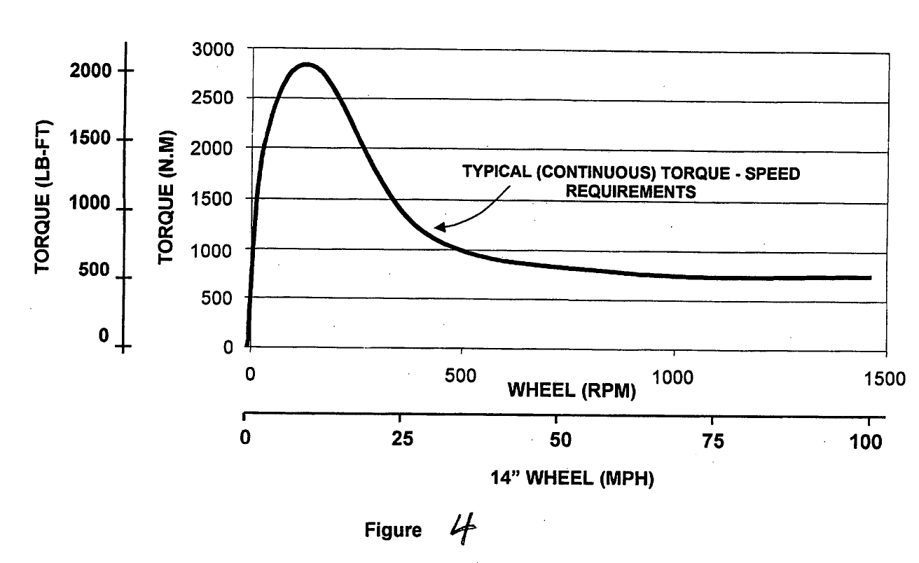

For another example, the torque-speed requirements are one key functional requirement for any control system for the motor used in an electric vehicle. A typical control system may be designed to meet the torque-speed requirements as shown in FIG. 4. The curve shown in FIG. 4 provides a high peak torque, but only within a limited range.

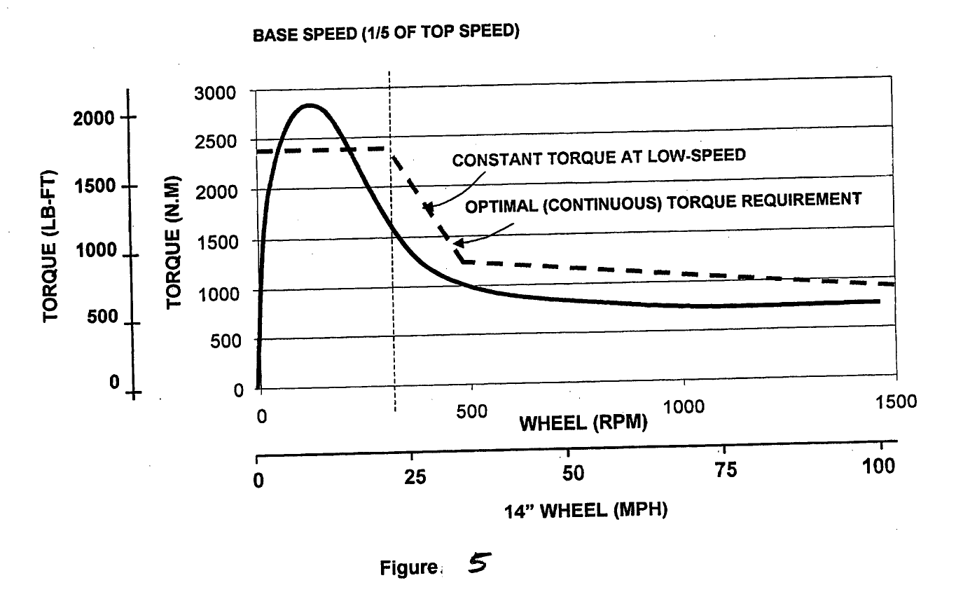

The optimal performance that a particular motor design is theoretically capable of is shown in the dotted line of FIG. 5. As shown in FIG. 5, constant torque at low speeds, from zero up to the motor's base speed, provides an optimal curve for most vehicle applications. In addition, at speeds above base speed the optimal torque exceeds that typically produced by motor control systems.

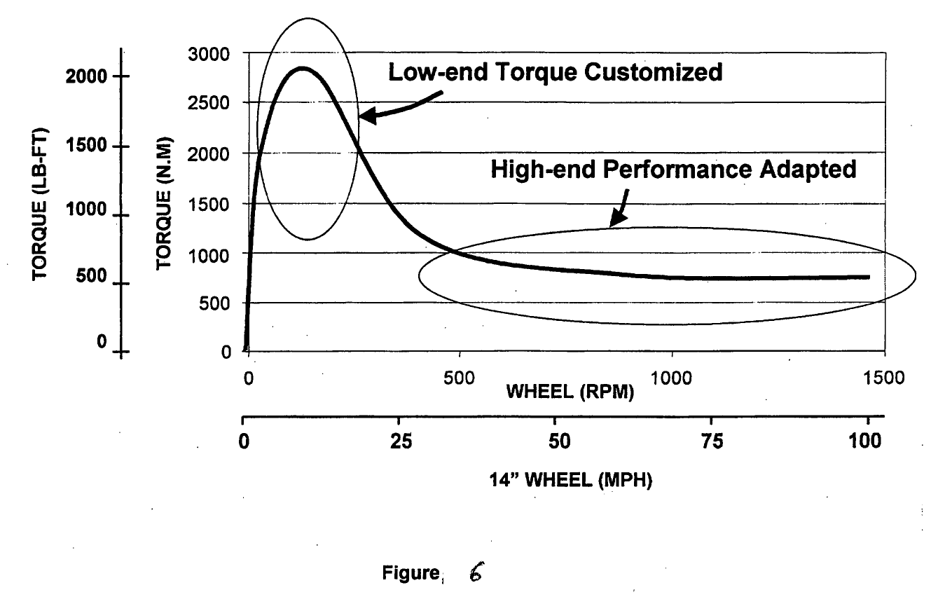

With the adaptive control system of this invention, functional requirements can be accomplished at a more optimal level. As shown in FIG. 6, control can be customized to produce an optimal torque-speed curve, within the constraints of the motor design. And performance can be adapted to produce optimal high-end torque, again within the constraints of the motor design.

With this adaptive control system, more than one motor control strategy can be used to control torque. As shown in FIG. 6, one control strategy can apply for low-end torque, a second for high-end torque.

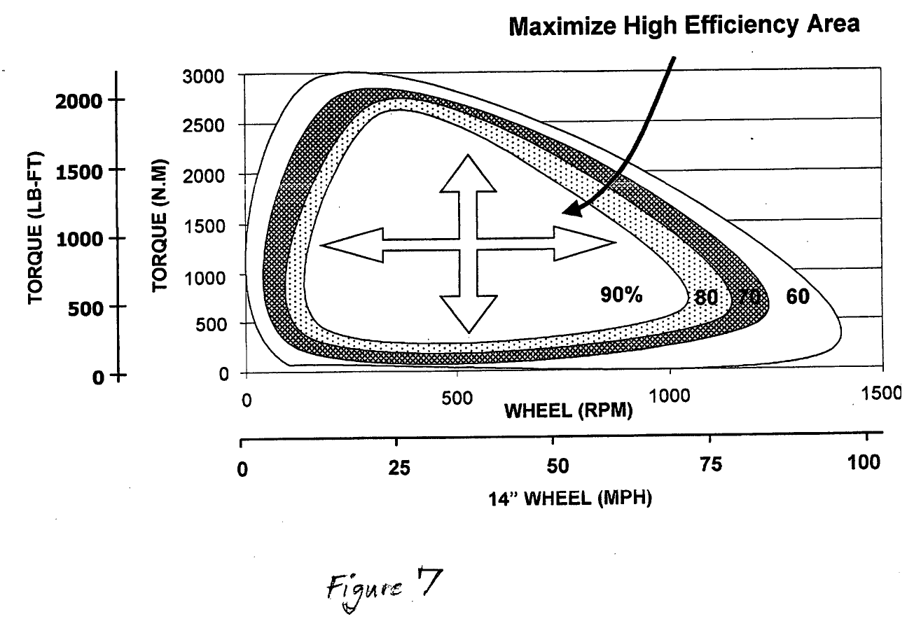

The same is true for the performance level of system efficiency. As shown in FIG. 7, efficiency for the motor in an electric vehicle application is not a two-dimensional function. FIG. 7 shows that to maximize overall efficiency, the area of high-efficiency must be made as great as possible.

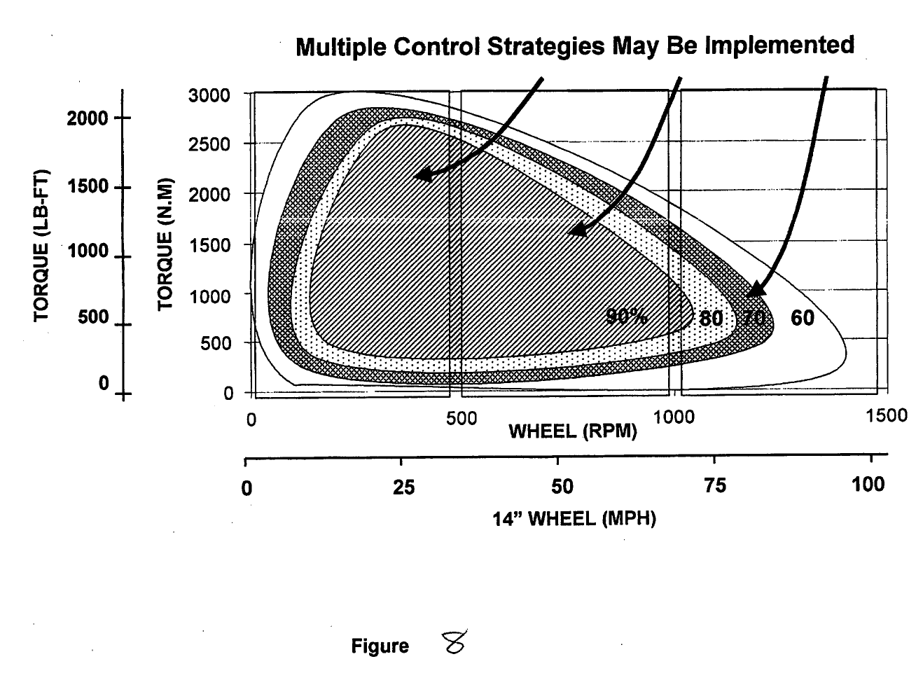

With this adaptive control system, more than one control strategy can be used to optimize efficiency. As shown in FIG. 8, one control strategy may be used at low speeds, a second at medium speeds, and a third at high speeds. Using more than one control strategy may result in increased efficiency in many applications.

In short, this adaptive control system allows the use of at least five levels of flexibility to produce at least five levels of performance. The end result—more optimization becomes possible, which can lead to improved overall performance.

### Types of Control Input Parameters

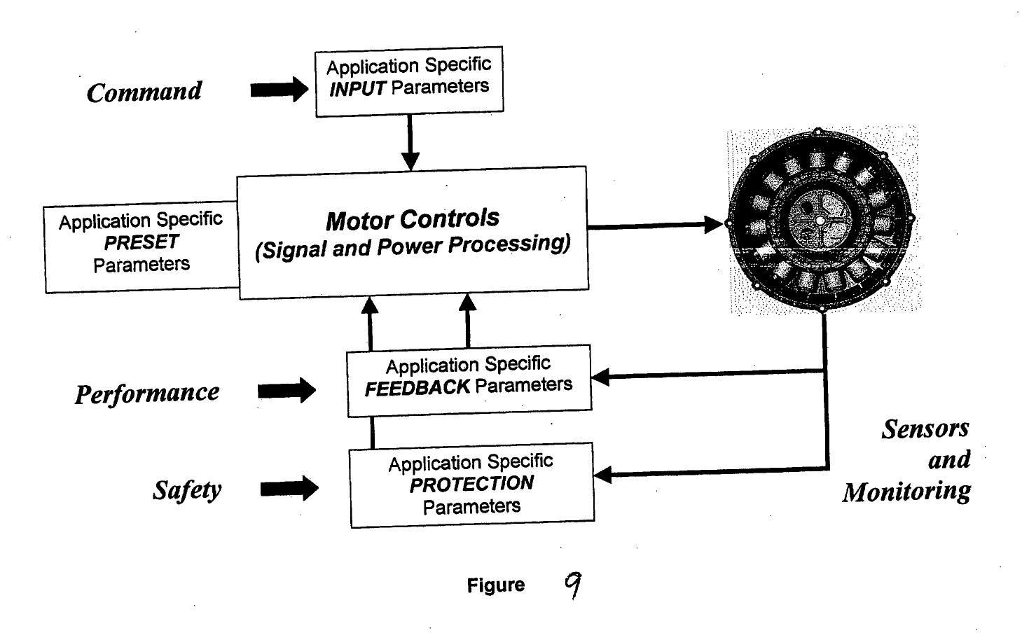

As shown in FIG. 9, the adaptive motor control system of this example has several parameters that are inputs to the signal and power processing. In this example, these application specific parameters fall into four categories: preset parameters, input parameters, feedback parameters, and protection parameters.

First, the motor preset parameters include the following:
Number of phases and magnetic pole pairs
Gross weight of the unit
Maximum weight of the unit
Min. and max. angular velocity
Min. and max. torque (derived)
Min. and max. gradient
Min. and max. current per phase
Min. and max. supply voltage per phase
Min. and max. operating temperature
Min. and max. back EMF per phase
Min. and max. duty cycle
L and R per phase
K_{W}, K_{EMF} and k_{T} constants (angular speed, EMF and torque gain factors)
Kₚᵢ and kᵢᵢ constants (partial and integral gain factors)
K_{pw} and k_{iw} constants (partial and integral angular speed gain factors)

Second, the user input parameters include the following:
Battery status
Power/throttle control
System temperature
System angular velocity
System total current consumption
System voltage consumption

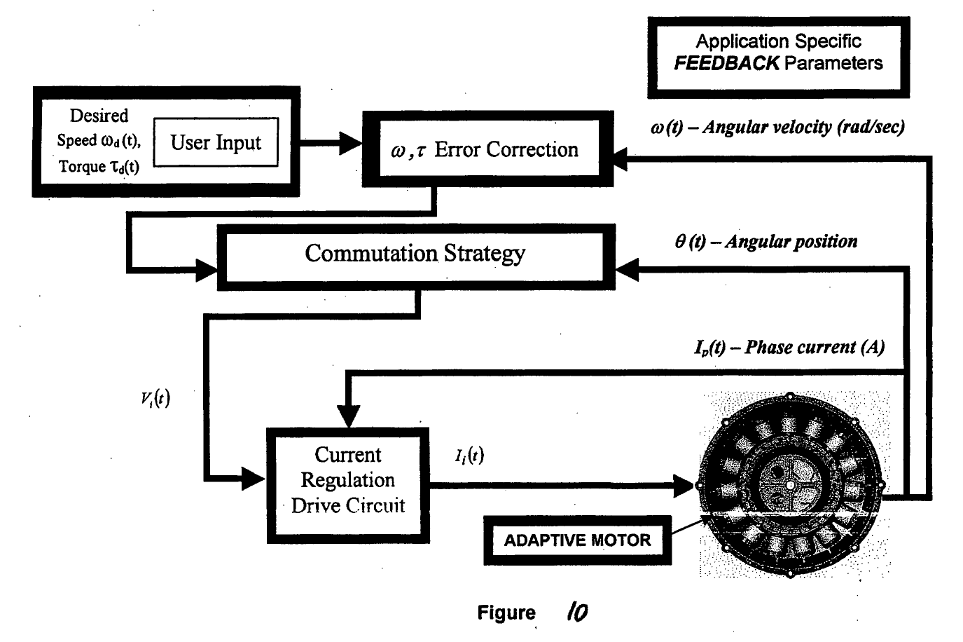

Third, the motor feedback parameters are shown in FIG. 10. They include angular velocity, angular position, and the current in each phase.

Fourth, the system protection parameters include the following:
Current over load shutdown for phase 1 to N
Short circuit shutdown for phase 1 to N
Thermal shutdown for phase 1 to N
System thermal shutdown
Low power system shutdown
Power supply failure/system shutdown
Battery monitoring

### Types of Output Parameters

The central idea behind the adaptive control concept may be to actively control enough variables during normal operations of the machine to achieve the specified goal function as closely as possible. The number and type of these variables—called here output parameters—will usually depend on the motor design.

When dealing with real-life complex optimization tasks, one should first identify all output parameters, or variables, that might possibly influence the goal function at minimization. For electric motors, these are generally electrical parameters of the excitation circuits (currents for each circuit, their profiles and frequencies, phase delays between individual circuits, and the like).

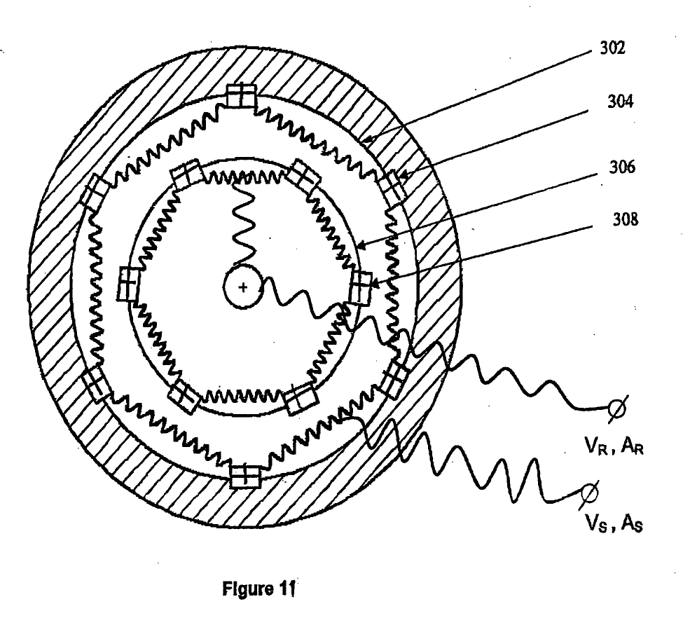

For example, FIG. 11 shows a schematic for a conventional electric motor. A magnetic stator 302 contains some magnets 304, which depending on the motor type, may be permanent magnets or electromagnets. The magnets 304 are all electrically and magnetically connected to each other. A rotor 306 with magnets 308, also either permanent or electromagnets, is also electrically and/or magnetically integrated.

The schematic of FIG. 11 covers a wide variety of AC and DC electric motors. The most conventional brushed DC motor would contain electromagnets 308 on the rotor 306, which are commutated by brushes, and permanent magnets 304 on the stator 302. Other types of DC motors include servomotors, step motors, and the like, which may have other designs but still the same general schematic.

Brushless motors would have permanent magnets 308 and electromagnets 304. Other types of DC motors, particularly wound DC motors, also fall under the same structure. AC motors also generally fall within this same arrangement. Normally, three-phase induction coil arrangements are made, with five phases and more being quite rare.

With this type of standard arrangement, most attention is devoted to the control of the input voltage V and current A, either just for the stator 302, or both stator 302 and rotor 306. In AC motors, all three phases can be controlled actively, and that ability is behind much of the progress currently being made in AC controllers. Servomotors, step motors, and wound motors can all control more than just two parameters, but are also limited in what can be controlled actively.

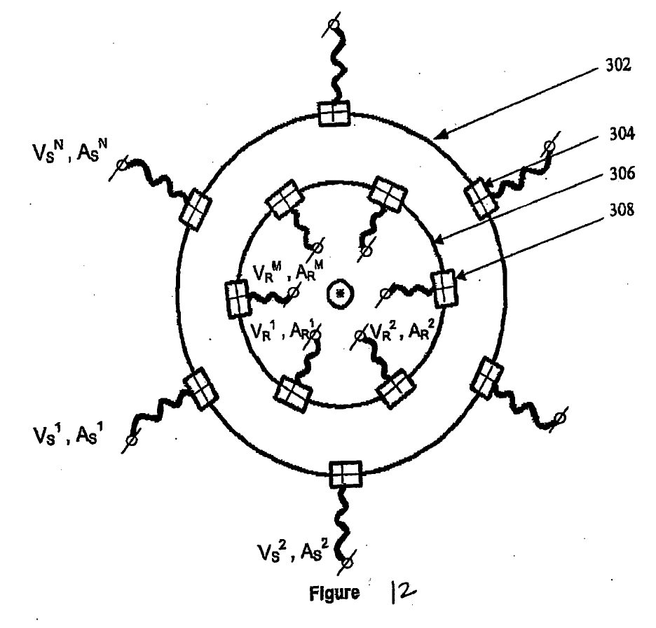

In the adaptive electric machine shown in FIG. 12, having N independent electromagnetic circuits for the stator 302 and M independent electromagnetic circuits for the rotor 306 gives 2*(N+M) independent variables to work with. By controlling these variables properly, the required goal function may be more closely approximated, which may be a significant difference of adaptive electric machine from conventional machines.

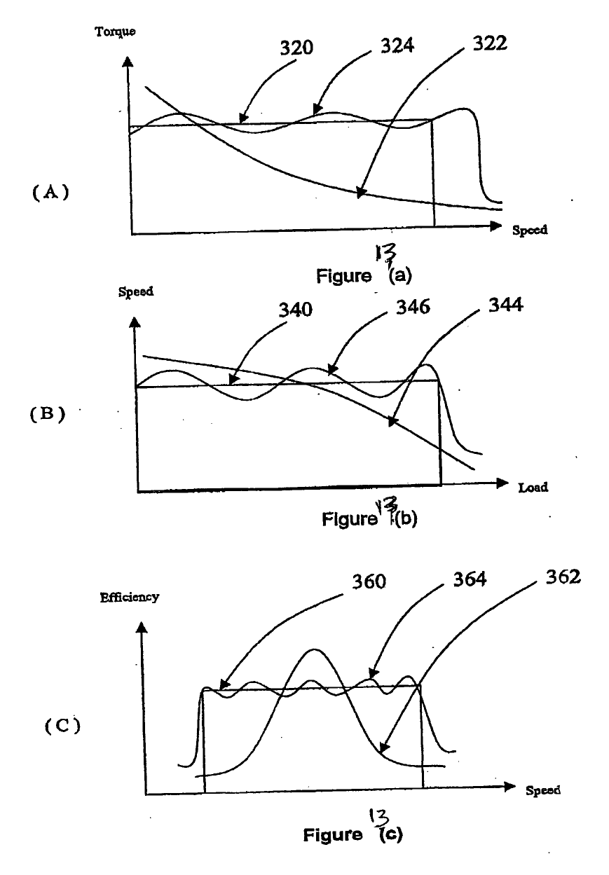

FIG. 13(a) defines the requirements for a motor with constant torque over certain range of operational speeds of the motor. The desired speed torque curve 320 is shown, as are the real torque-speed curve of conventional motors 322, and the curve 324 that may be achievable through optimization with multiple variables in an adaptive electric motor.

FIG. 13(b) shows an ideal required goal function 340 in applications where constant speed is required over the range of operational loads on the shaft of the motor, typical conventional motor characteristics 342, and performance possibilities 344 of an adaptive motor.

Similar to the above, FIG. 13(c) deals with the goal function requiring specific high efficiency over the range of motor speeds or loads. Such requirements arise in some energy-limited applications, for example, space flight applications or battery-driven motors. This FIG. 13(c) shows the goal function 360, what conventional motors can deliver 362, and the optimized characteristics 364 for an adaptive motor.

With an adaptive architecture, a very large number of variables may be controlled, effectively and independently, within the machine. Within each electromagnetic circuit, current amplitude and current profile (frequency, shape, phase delays of the start and stop of the profile, etc.) may be controlled individually and independently. As the number of electromagnetic circuits increases, so may the number of controllable variables for the whole motor.

But there are other ways to make motors and generators more susceptible to control. Mechanically or electromechanically controlled parameters may be added. This may be done by varying the numbers of coils or turns energized at different windings of the motor.

For example, the windings on an electromagnetic pole may have a switch halfway along the winding. Depending on the speed of the motor, the switch is used to allow current to flow through the entire winding (at low speed) or just half the winding (at high speed).

Other possibilities include variable air gap size or variable reluctance. These are most often controlled by electromechanical means but could also be accomplished by using material with electromagnetically-dependent dimensional properties.

Segmented motors may be used. In these motors, separate physical segments of the motor can be independently activated or energized. Or there may be a commutated number of motor segments or parts for multi-segmented motors. This may include multiple air gap motors, or multiple stator axial motor arrangements.

Most often this is done in the form of an axial air gap flux motor with several stator assemblies coaxially connected to the same shaft or stator frame. But radial flux arrangements are also known. Some names used for such arrangements are segmented electromagnetic motor arrays, cascaded motor arrangements, motor clutching, and the like.

Some conventional three-phase motors try to introduce several independent higher order harmonics in the sine-wave shape of the current injected into each of the three phases. These harmonics add some variation to the current shape to be injected.

With this adaptive control system, increasing the number of variables, or output parameters, will generally result in more opportunity to optimize, and thus better performance.

### Algorithms to Achieve Goal Functions

The algorithms used in an adaptive control system of this invention may be chosen and developed to accomplish the desired goal function. The goal function will depend on the each application. Any of a variety of control algorithms known in the art may be used.

In this example of an adaptive control system for an adaptive motor used in an electric vehicle, we will describe one sample algorithm. That algorithm shapes a waveform profile to obtain the desired torque as efficiently as possible. At the same time, the algorithm provides for phase advance as back EMF starts to affect the driving signal.

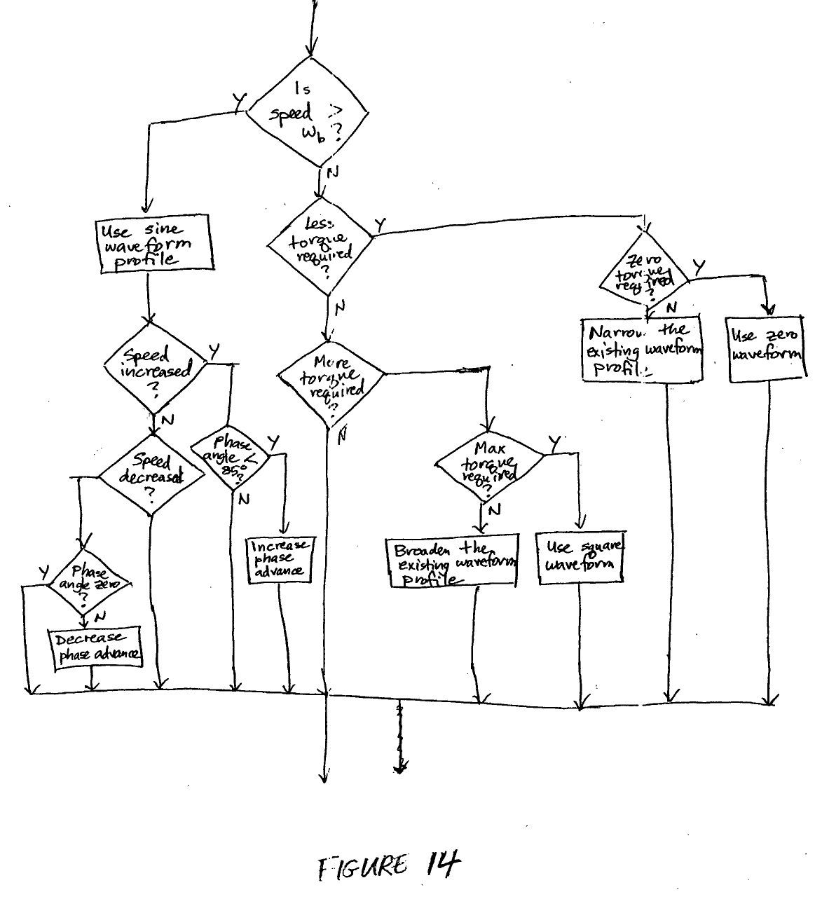

The flowchart in FIG. 14 shows the sample algorithm. The angular speed Cob is the speed at which the ability to inject current into the motor windings becomes affected due to back EMF.

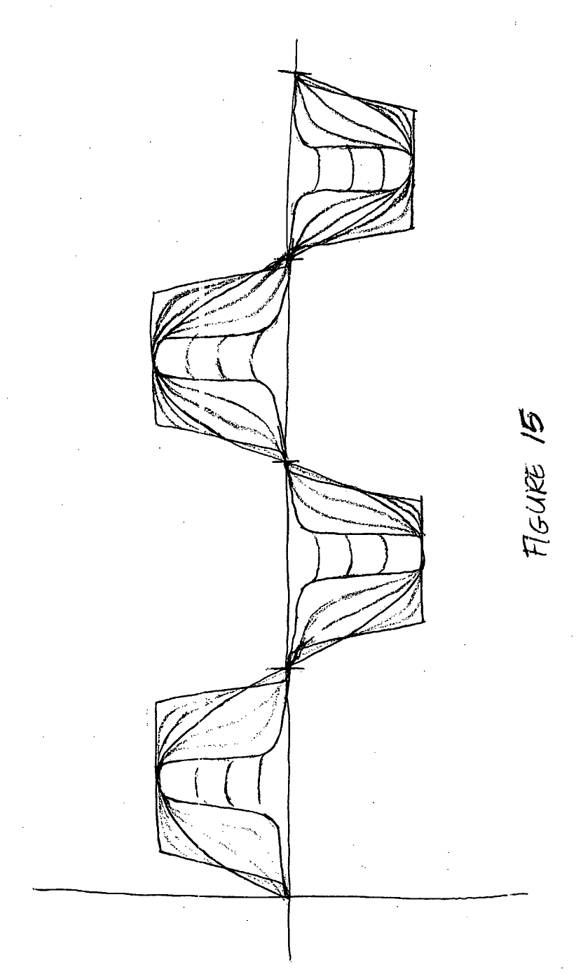

FIG. 15 shows the shape of the waveform profile as more or less torque is required. When zero torque is required, the waveform is flat, or the “zero waveform.”

When maximum torque is required, the waveform is a trapezoid with dead zones, or a near “square waveform.” In between is the “sine waveform.”

As shown in the flowchart of FIG. 15, as more torque is requested, the existing waveform profile is broadened. So when the waveform goes from the zero waveform to generate some torque, the current is injected into the motor windings at the time when the least amount of current will get the most amount of torque. That is the small rise in the middle of the waveform.

As torque demand increases, the height of the bulge in the middle of the waveform increases. When it reaches maximum height, it begins to broaden to the sine waveform. As torque increases, the waveform broadens and rises to the square waveform.

If the angular speed of the motor exceeds Cob, the waveform switches to the sine waveform so that phase advance may be implemented. As the speed of the motor increases, so does the angle of the phase advance. When it reaches the maximum, here set at 85°, it no longer changes.

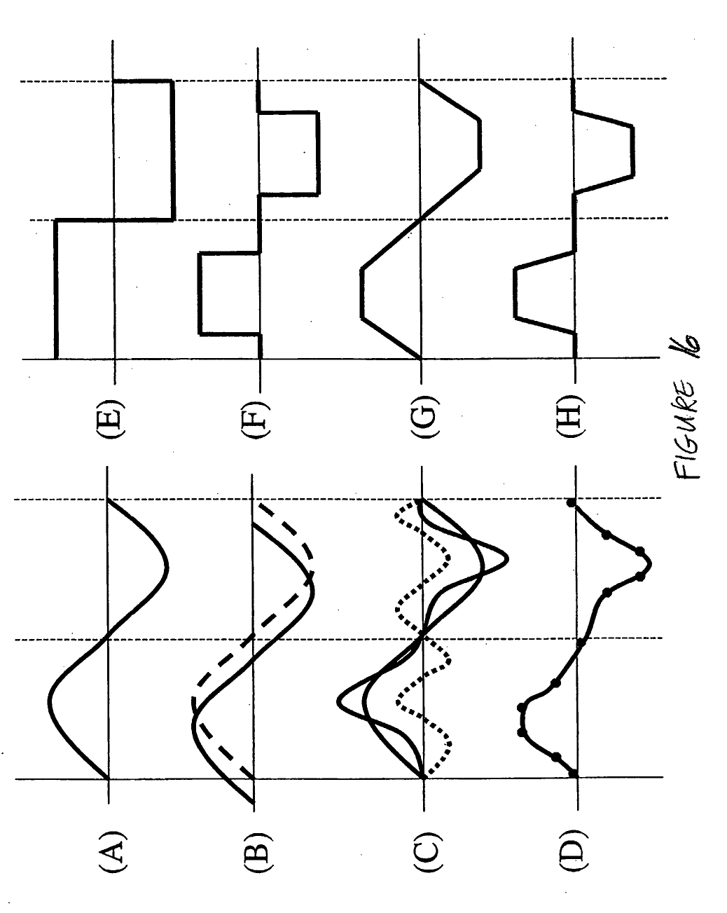

FIG. 16 shows some waveform profiles that can be used with the adaptive control system of this invention to vary motor performance. By choosing a waveform profile, and then dynamically adapting the height, period, or even the profile itself as conditions change, performance may be optimized.

The waveform profiles shown in FIG. 16 are: (a) sinusoidal, (b) sinusoidal with phase advance, (c) sinusoidal with odd harmonics, (d) arbitrary waveform, (e) square wave (100% duty cycle), (f) square wave pulse (<100% duty cycle), (g) trapezoidal, and (h) trapezoidal with dead zones.

### Hardware of the Adaptive Control System

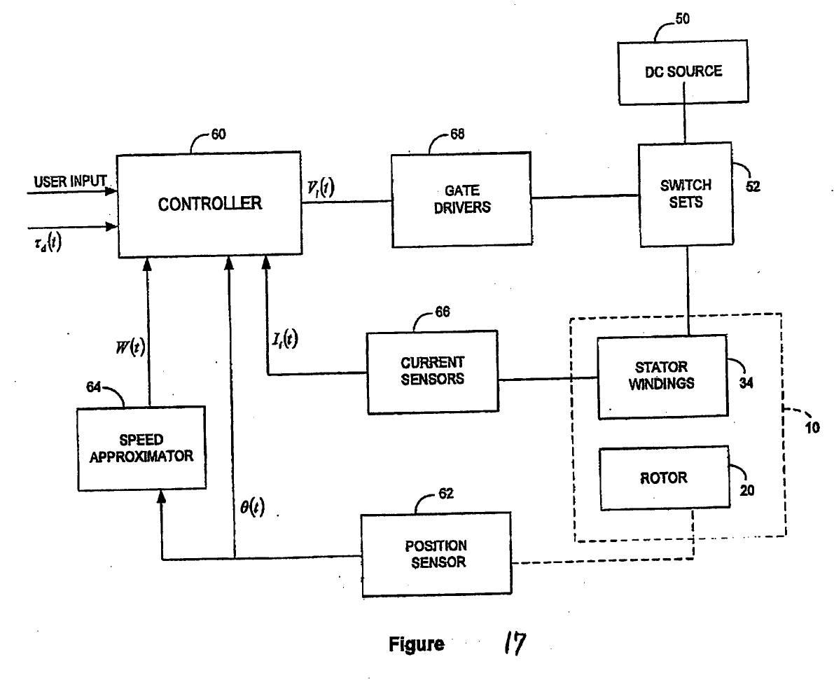

FIG. 17 shows a block diagram of the various hardware components that make up the adaptive control system of this example. In this example, the via electronic switch sets 52, one for each set of stator windings 34, energize the stator windings 34 with driving current from a power source 50.

A MOSFET H-bridge, such as International Rectifier IRFIZ48N-ND, may be used as an electronic switch set 52. The controller 60 regulates timing of the current pulses to each of the stator windings 34.

In this example, the controller 60 responds to feedback signals received from a position sensor 62, and also to a speed approximator 50. A current sensor 66 senses the current in each phase winding 34, and sends that information to the controller 60. A Hall-effect current sensor, such as F.W. Bell SM-15, may be used. In addition, the controller 60 may be able to receive various other inputs, such as vehicle conditions.

A Texas Instrument digital signal processor TMS320LF2407APG acts as the controller 60 in this example. A Hall-effect device (in this case an Allegro Microsystems 92B5308) acts as the position sensor in this example. But a variety of position sensors can be used. Another Hall effect device, a giant magneto resistive (MGR) sensor, a reed switch, a pulse wire sensor including an amorphous sensor, a resolver or an optical, magnetic, inductive or capacitive sensor—any of these can be used.

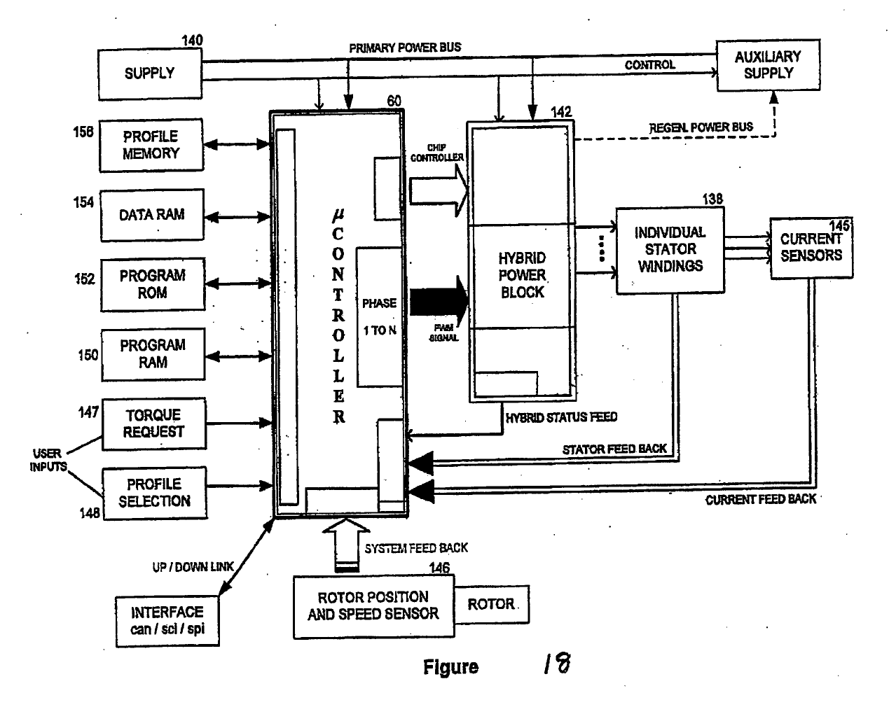

FIG. 18 shows another block diagram, this time of the hardware elements of the adaptive motor control system of this invention. The control system implementation for an adaptive electric generator may differ in some respects.

1. An adaptive control system, comprising a control system having means for dynamically selecting from at least two different control strategies during machine operation to optimize one or more goal functions as the machine's operating conditions vary.

2. An adaptive control system, comprising a control system having controller that selects from among two or more excitation profiles to optimize the performance of the machine according to a parameter selected from the group consisting of feedback, voltage, current, flux, torque, speed, or combinations thereof.

3. An adaptive control system according to claim 2, comprising an electric machine with a rotor, a stator, and two or more electromagnetic circuits, wherein each of the electromagnetic circuits is structurally separated from each other circuit and the control system has a controller for dynamically controlling the electrical flow in each electromagnetic circuit independently from each other circuit.

4. An adaptive control system according to claim 3, wherein the adaptive control system has a controller for dynamically adapting the waveform profile for the electrical flow in each electromagnetic circuit according to the operating conditions of the machine.

5. An adaptive control system according to claim 4, comprising a software program for carrying out a control system with different control strategies.

6. A method for controlling an electric machine, comprising:
sensing one or more operating conditions of the electric machine, and
dynamically configuring the control scheme of the machine to adapt to variations in the operating conditions.

7. A method for optimizing performance of an electric machine, compsiring:
identifying and maximizing independent machine parameters that will be controlled by a control system of the machine;
selecting one or more sensed parameters, the sensed parameters selected from the group consisting of user inputs, machine operating conditions, machine operating parameters, and combinations thereof, that will be periodically sensed during operation of the machine; and
dynamically changing the controlled parameters to changes in the sensed parameters.
